(19) United States
(12) Patent Application Publication
(10) Pub. No.: US 2012/0194400 A1
(43) Pub. Date: Aug. 2, 2012

(54) High power broadband antenna

(75) Inventors: Jean-Pierre Brasile, Colombes (FR); Friedman Tchoffo Talom, Colombes (FR); Patrick Sirot, Colombes (FR); Dominique Fasse, Colombes (FR)

(73) Assignee: THALES, Neuilly Sur Seine (FR)

(21) Appl. No.: 13/336,603

(22) Filed: Dec. 23, 2011

(30) Foreign Application Priority Data
Dec. 27, 2010 (FR) 1005127

(51) Int. Cl. H01Q 13/00

(52) U.S. Cl. 343/776

(57) ABSTRACT

The invention relates to an antenna comprising a transmission surface, an array of elementary antennas each extending from the transmission surface, first and second superimposed electromagnetic waveguides. The first waveguide is adapted to power the second waveguide from a collection inlet, and the second waveguide is adapted to power the elementary antennas. The antenna comprises means for coupling the electromagnetic energy associated with the electromagnetic wave between the first and second waveguides. The coupling means separate the transmission surface into two concentric regions made up of a peripheral region and an internal region situated at the collection inlet, each comprising at least one elementary antenna.

### BACKGROUND

The present invention relates to a high power broadband antenna, of the type comprising a transmission surface, an array of elementary antennas each extending from the transmission surface, first and second superimposed electromagnetic waveguides, the first waveguide being adapted to power the second waveguide from a collection inlet, the second waveguide being adapted to power the elementary antennas, and means for coupling the electromagnetic energy associated with the electromagnetic wave between the first and second waveguides.

The invention applies to the field of radiocommunications and very high power scrambling.

Known, in particular from the article by X. Q. Li entitled “The high power radial line helical circular array antenna: theory and development,” is an antenna having a generally discoid transmission surface. Along its transmission surface, the antenna comprises a set of regularly distributed radiating antenna elements. Each antenna element comprises a helical radiating strand protruding from the transmission surface. The strand is connected to a pick-up loop present inside the antenna on the other side of the transmission surface. Each of the helical radiating strands is oriented angularly, so as to form a coherent electromagnetic field whereof the propagation direction is perpendicular to the transmission surface.

In order to power the antenna elements, it is known to use an electromagnetic radiation source, for example made up of a MILO (Magnetically Insulated Line Oscillator), a carcinotron, a relativistic klystron or a high-power magnetron, and a waveguide for conveying the electromagnetic flow from the source to the antenna elements.

The antenna described in the article by X. Q. Li comprises a waveguide comprising two radial transmission lines of the field in the shape of a crown connected to their outer peripheries by a cylindrical waveguide extending perpendicular to the radial transmission lines so as to guide the electromagnetic field in a vacuum while reducing breakdown phenomena.

In this antenna, the power transmitted in the outer cylindrical waveguide is very significant, since it is equal to the total power transmitted by the antenna, but is distributed over the entire circumference, which limits the breakdown risks in that part of the antenna. They nevertheless remain high due to the sinuous shape of that part of the antenna if the latter is too short. The thickness of the antenna is therefore significant for the transmission of very high powers without breakdowns.

Furthermore, it is known that to obtain a high-gain antenna while limiting breakdown phenomena, it is necessary to have antennas with a large diameter, thereby causing a degradation of the bandwidth of the antenna during operation.

The invention aims to propose a radiofrequency antenna making it possible to be used at a high power, with a small thickness, capable of operating on a wide frequency band, while limiting breakdown phenomena.

To that end, the invention relates to an antenna of the aforementioned type, characterized in that the coupling means separate the transmission surface into two concentric regions made up of a peripheral region and an internal region situated at the collection inlet, each comprising at least one elementary antenna.

According to particular embodiments, the antenna comprises one or more of the following features:
the peripheral region comprises more elementary antennas than the inner region;
it comprises a metal wall delimiting the first and second waveguides;
the coupling means are an array of loops made from a conducting material passing through the wall;
the means for coupling the energy between the first and second waveguides are situated at an average distance from a plane or axis of symmetry of the antenna;
the average distance is substantially equal to half the distance from the end of the transmission surface to the plane or the axis of symmetry of the antenna;
the average distance is chosen to be as small as possible while avoiding the breakdown phenomenon at the coupling means;
it comprises energy absorption means situated at the peripheral ends of the first and/or second waveguides;
the energy absorption means have a beveled side opposite the inside of the first and/or second waveguides and are made from pyrolytic carbon; and
the outer peripheral end of the first waveguide is closed by a dielectric material and in that the distance between the coupling means and the outer peripheral end of the first waveguide is substantially equal to one quarter of the wavelength of the radiofrequency waves propagating in the first waveguide.

### BRIEF DESCRIPTION OF THE DRAWINGS

The invention will be better understood upon reading the following description, provided solely as an example, and in reference to the drawings, in which:

FIG. 1 is a front view of an antenna according to the invention; and

FIG. 2 is a diagrammatic cross-sectional view of the antenna according to the invention.

The invention relates to an antenna of a transmission facility on a broad frequency band constituting a scrambler or a microwave weapon capable of transmitting, in a particular direction, a high power electromagnetic field intended to disrupt or destroy any device comprising electronics.

This facility generally comprises a radiofrequency source, for example made up of a magnetron, and an antenna connected to the source by a guide means or a waveguide for the flow or electromagnetic wave generated by the source.

According to the invention, the antenna 10 comprises a transmission surface 12 and an array of elementary antennas 14 each extending from the transmission surface 12. For example, the elementary antennas 14 are distributed in concentric circles on the transmission surface 12 of the antenna.

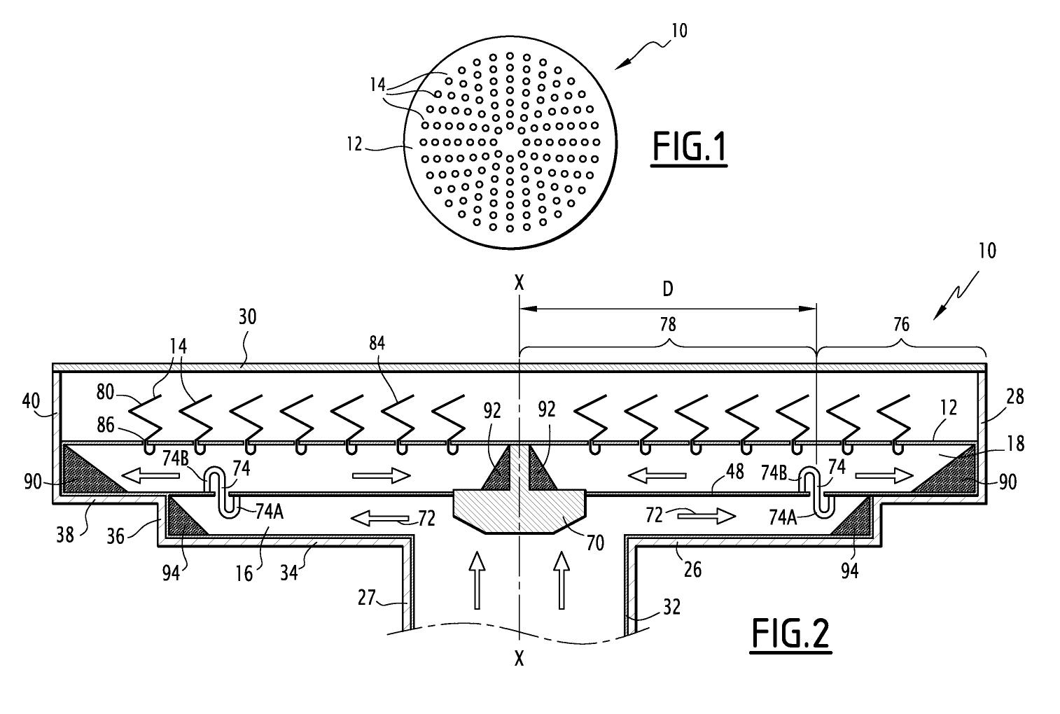

As illustrated in FIG. 1, the antenna is of revolution with axis X-X around an axis perpendicular to the transmission surface 12. For example, it is circular. Alternatively, the transmission surface is a half-sphere or any other three-dimensional surface, and as a result it suffices to adjust the phase of the elementary antennas.

According to another alternative, the antenna is square or rectangular.

More generally, the antenna has a plane of symmetry comprising an axis of symmetry X-X. The plane of symmetry is perpendicular to the illustrated cutting plane. It is powered by the radiofrequency source along the plane of symmetry, and in particular along the axis of symmetry when one exists.

Furthermore, the antenna comprises first 16 and second 18 superimposed waveguides adapted to propagate the electromagnetic flow generated by the source, as well as the energy associated with that flow.

These waveguides are made up of two coaxial and adjacent crowns in the considered example.

The first waveguide 16 is connected at the center thereof to the guide means connected to the radiofrequency source. The first waveguide 16 is adapted to centrifugally propagate the electromagnetic energy transmitted by the guide means and intended to power the second waveguide 18. The second waveguide 18 is adapted to power the elementary antenna array 14. The transmission surface 12 forms a side wall of the second waveguide 18.

The assembly formed by the two waveguides is supported by a chassis 26 in the general shape of a bell gradually flaring from a collection inlet 27 of the magnetic radiation emitted by the source to an outlet mouth 28 for the radiation coming from the elementary antennas 14. This mouth is covered by an airtight protective wall 30 making it possible to create the vacuum inside the chassis 26. This wall 30 is transparent to the electromagnetic radiation and forms a radome.

The inlet end 27 of the chassis 26 is formed from a tube 32 extended by a crown 34 forming the bottom of the chassis. This crown has axis X-X. The bottom is extended by a first peripheral wall 36 having, at its end turned toward the mouth 28, a divergent shoulder 38. This shoulder 38 is bordered by a second peripheral wall 40 supporting the protective wall 30.

The second waveguide 18 bears on the support formed by the diversion shoulder 38. Similarly, the first waveguide 16 bears on the bottom of the chassis formed by the crown 34.

The first and second waveguides have a shared continuous metal wall 48 extending parallel to the transmission surface 12 and positioned between the transmission surface 12 and the bottom 34. This shared wall 48 delimits the two waveguides.

The shared wall 48 supports, opposite the tube 32 along axis X-X, a metal cone 70 capable of modifying the propagation mode of the electromagnetic flow, by going from a flow along axis X-X, for example in the magnetic transverse mode TM₀₁, to a centrifugal flow extending from the axis X-X outward in the direction of the arrows 72, for example in the electric and magnetic transverse mode EMT. In a known manner, this metal cone 70 is referred to as a mode converter.

The intermediate wall 48 is provided with an array of pick-up and coupling means for the electromagnetic energy between the first and second waveguides. This pick-up and coupling means for example comprises through loops 74 regularly distributed at a distance D from the axis X-X.

The through loops 74 are thus regularly distributed in a circle with radius D and centered on the axis X-X.

These loops 74 are formed from a metal conductor and have two lobes 74A, 74B protruding on either side of the intermediate wall 48.

According to one alternative, the pick-up and coupling means for example comprise through rods regularly distributed at a distance D from the axis X-X and adapted to pick up the electric field. The through rods are thus distributed regularly along a circle with radius D and centered along axis X-X. These rods are formed from a metal conductor protruding on either side of the intermediate wall 48.

The array of through loops 74 divides the transmission surface into two contiguous regions centered along the axis X-X. Each region comprises at least one elementary antenna 14. The so-called peripheral region denoted 76 comprises the elementary antennas situated at a distance from the axis X-X greater than the distance D, while the so-called inner region denoted 78 comprises the elementary antennas situated at a distance from the axis X-X smaller than or equal to the distance D. Preferably, the peripheral region comprises more elementary antennas than the inner region.

According to one alternative, the intermediate wall 48 is provided with at least one other array of pick-up and coupling means for the electromagnetic energy between the first and second waveguides. The pick-up and coupling means of this other array comprises through loops identical to those previously described. The two arrays of pick-up and coupling means are concentric around the axis X-X and have an identical shape. The dimensions of the assembly formed by the arrays of pick-up and coupling means are adapted so that the through loops 74 are regularly distributed at an average distance D from the plane of symmetry of the antenna comprising the axis X-X, as previously defined.

The distance D is substantially equal to half the radius of the transmission surface.

Alternatively, in order to limit the bulk and weight of the antenna, the distance D is chosen as a function of the power of the radiofrequency source to be as small as possible while avoiding, however, the breakdown phenomenon at the lobes 74A. In fact, the power density is lower as the loops 74 are further from the center.

Each elementary antenna 14 comprises a transmission strand 80 positioned on the side of the transmission mouth of the antenna and a pick-up loop 86 positioned between the transmission surface 22 and the shared wall 48, in the second waveguide 18.

The loop 86 is rigidly and securely connected to the wall forming the transmission surface 12. Its surface is determined as a function of the power one wishes to collect. The loop has a shape known in itself and is obtained by curving a metal conductor on itself.

The strand 80 has a transmission part 84 made from a metal wire describing a helical shape. This transmission part is electrically connected to the pick-up loop 86, and the transmission surface 12 is pierced to allow it to be connected with the loop 86.

Furthermore, the second waveguide 18 of the antenna comprises energy absorbing means 90 situated at the periphery thereof and other energy absorbing means 92 situated around the axis X-X. These absorbing means make it possible to reduce stray reflections.

For example, these energy absorbing means 90, 92 are made from pyrolytic carbon and have a beveled side opposite the inside of the first and/or second waveguide 16, 18.

The first waveguide 16 also comprises energy absorbing means 94 situated at the peripheral ends thereof so as, on the contrary, to allow the reflection of the residual electromagnetic flow so that the reflected wave can be collected, with the proper phase, by the pick-up loops 74A. This reflection is obtained, for example, by a short circuit allowing a reflection of the wave. This short circuit is situated at a distance from the pick-up loops 74A equal to half the wavelength of the radiofrequency waves propagating in the waveguides. This short circuit is for example obtained by a metal wall.

According to another alternative, the peripheral ends of the first waveguide are made from a dielectric material and enable the mechanical maintenance of the shoulder 38 on the chassis 26 as well as vacuum tightness. From an electromagnetic perspective, this alternative corresponds to an open circuit of the waveguide 16 allowing a reflection of the wave, said open circuit being situated at a distance from the pick-up loops 74A equal to one quarter of the wavelength of the radiofrequency waves propagating in the waveguides. This open circuit is for example made up of an orifice or a crown made from a dielectric material.

During operation, in one such antenna, the electromagnetic flow arriving along the axis X-X through the inlet 27 is distributed over the first waveguide 16 by the mode converter 70. The propagation direction of the flow is shown by the arrows in FIG. 2.

The flow, then centripetal, is picked up by the lobes 74A of the loops and retransmitted by the lobes 74B into the space between the transmission surface 12 and the shared wall 48. The flow is then divided into two flows: a centrifugal flow and a centripetal flow to power the elementary antennas 14 of the peripheral region and the inner region of the transmission surface 12, respectively. The loops 86 of the elementary antennas 14 pick up the electromagnetic wave, in particular the magnetic field, causing a current up to the transmission strand 84, which retransmits the electromagnetic wave in a direction with a phase determined by the angular position of the elementary antenna 14.

Any excess energy of the electromagnetic waves is absorbed by the absorbing means 90, 92, 94 situated at the ends of the first and second waveguides.

In the alternative according to which the outer peripheral end of the first waveguide is open, the electromagnetic waves propagate centrifugally and reflect at the outer peripheral end of the first waveguide. Since the distance between the pick-up and coupling means and the outer peripheral end of the first waveguide is equal to one quarter of the wavelength, the reflected waves propagate centripetally in phase with those propagating centrifugally, such that they are added together at the lobes 74A of the coupling means, thereby improving the coupling.

In the alternative according to which the outer peripheral end of the first waveguide is a metal wall forming a short-circuit, the electromagnetic waves propagate centrifugally and reflect at the outer peripheral end of the first waveguide. Since the distance between the pick-up and coupling means and the outer peripheral end of the first waveguide is equal to half of the wavelength, the reflected waves propagate centripetally in phase with those propagating centrifugally, such that they are added together at the lobes 74A of the coupling means, thereby improving the coupling.

According to the invention, the number and features of the coupling means are optimized to withdraw practically all of the power propagating in the first waveguide and injected into the second waveguide without breakdown.

Furthermore, the power absorption means 90 at the peripheral ends of the second waveguide make it possible to reduce the reflections harmful to the operation of the power tube, thereby limiting the stationary wave rate (SWR) and improving the level of the secondary transmission lobes, such that the stealth of the antenna is improved.

The retransmission of the electromagnetic wave by the lobes 74B at a distance D substantially equal to half the distance from the peripheral end of the transmission surface 12 contained in the plane perpendicular to the plane of symmetry of the antenna makes it possible to reduce the propagation time, in this case by half, so that the frequency bandwidth of the antenna is improved relative to conventional radial transmission line antennas. This reduced filling time authorizes the high gain transmission by the antenna of ultra-short pulses, for example nano seconds.

Furthermore, this position for the retransmission of the electromagnetic wave by the lobes 74B facilitates apodization of the electromagnetic wave transmitted by the elementary antenna array 14 resulting:
on the one hand, from the natural decrease of the law of illumination of the centrifugal electromagnetic flow propagating toward the peripheral elementary antennas, and
on the other hand, from the compensation of the natural decrease of the law of illumination of the centripetal electromagnetic flow propagating toward the inner elementary antennas by decreasing the distance of the elementary antennas from the plane of symmetry of the antenna.

Another advantage of the antenna according to the invention is that the electromagnetic waves propagate in the waveguides while preventing the resonance phenomenon, which limits the breakdown phenomena and thereby also authorizes broadband operation.

The antenna according to the invention also makes it possible to decrease its dimensions, making it possible to reduce the volume necessary for effective pumping of the vacuum and better physical strength.

The invention has been described in the context of a circular antenna. However, it is applicable to other antennas with square or rectangular shapes, for example. In that case, the distance D between the pick-up and coupling means is defined so as to best distribute the flow from a plane of symmetry of the antenna.

1-10. (canceled)

11. An antenna comprising a transmission surface, an array of elementary antennas each extending from the transmission surface, first and second superimposed electromagnetic waveguides, the first waveguide being adapted to power the second waveguide from a collection inlet, the second waveguide being adapted to power the elementary antennas, and means for coupling the electromagnetic energy associated with the electromagnetic wave between the first and second waveguides, wherein the coupling means separate the transmission surface into two concentric regions made up of a peripheral region and an internal region situated at the collection inlet, each comprising at least one elementary antenna.

12. The antenna according to claim 11, wherein the peripheral region comprises more elementary antennas than the inner region.

13. The antenna according to claim 11, comprising a metal wall delimiting the first and second waveguides.

14. The antenna according to claim 13, wherein the coupling means are an array of loops made from a conducting material passing through the wall.

15. The antenna according to claim 11, wherein the means for coupling the energy between the first and second waveguides are situated at an average distance from a plane or an axis of symmetry of the antenna.

16. The antenna according to claim 15, wherein the average distance is substantially equal to half the distance from the end of the transmission surface to the plane or the axis of symmetry of the antenna.

17. The antenna according to claim 15, wherein the average distance is chosen to be as small as possible while avoiding the breakdown phenomenon at the coupling means.

18. The antenna according to claim 11, comprising energy absorption means situated at the peripheral ends of the first and/or second waveguides.

19. The antenna according to claim 18, wherein the energy absorption means have a beveled side opposite the inside of the first and/or second waveguides and are made from pyrolytic carbon.

20. The antenna according to claim 11, wherein the outer peripheral end of the first waveguide is closed by a dielectric material and in that the distance between the coupling means and the outer peripheral end of the first waveguide is substantially equal to one quarter of the wavelength of the radiofrequency waves propagating in the first waveguide.
